(19) United States
(12) Patent Application Publication
(10) Pub. No.: US 2026/0264339 A1
(43) Pub. Date: Sep. 10, 2026

(54) CURING PROCESS FOR WIND TURBINE ROTOR BLADES

(71) Applicant: Vestas Wind Systems A/S, Aarhus N. (DK)

(72) Inventor: Jeremy Haight, Arvada, CO (US)

(73) Assignee: Vestas Wind Systems A/S, Aarhus N. (DK)

(21) Appl. No.: 19/168,989

(22) PCT Filed: Apr. 4, 2024
(86) PCT No.: PCT/DK2024/050080

§ 371 Date: Sep. 25, 2025

Related U.S. Application Data
(60) Provisional application No. 63/494,079, filed on Apr. 4, 2023.

(30) Foreign Application Priority Data
Apr. 19, 2023 (DK) PA202370182

(51) Int. Cl. B29C 65/10; B29C 65/48; B29L 31/08

(52) U.S. Cl. CPC B29C 65/10; B29C 65/4835; B29L 2031/085

(57) ABSTRACT

A method and a device (10) are provided for curing a bond joint in a wind turbine blade manufacturing process. The device (10) comprises a mobile frame (20), a root cap (30) configured to be coupled to a root end of a wind turbine blade (6) that is being manufactured, a seal (50) provided on the root cap (30), a hot air duct (41) passing through the root cap (30) and arranged to blow hot air into a blade cavity of the wind turbine blade (6), and a return duct (43) passing through the root cap (3) and arranged to receive a return flow of air from the blade cavity. The method comprises mechanically coupling the root cap (30) to the root end, inflating an inflatable seal (50), and blowing hot air through into the blade cavity.

### TECHNICAL FIELD

The invention relates to a method of curing a bond joint in a wind turbine rotor blade manufacturing process. The invention further relates to a mobile heating device for use in such method.

### BACKGROUND

Wind turbines as known in the art include a wind turbine tower supporting a nacelle and a rotor with a number of—typically, three—rotor blades mounted thereto. The blades of modern wind turbines generally comprise a hollow blade shell defining the aerodynamic contour of the blade. The hollow blade shell is typically formed of composite materials, such as glass-fibre reinforced plastic. In a typical manufacturing process, windward and leeward half shells are manufactured in respective half moulds of a blade mould assembly. The thus produced half shells are put together to define the aerodynamic contour of the blade. One or more longitudinally-extending shear webs are installed inside the hollow blades and act as the main loadbearing structures thereof. A shear web is configured to take up the shear loads experienced by the wind turbine blade in use, and is connected between inner surfaces, such as spar caps, of the opposing windward and leeward sides of the shell.

The shear web is connected to the blade shells or spar caps using a glue or binding resin. To improve bonding and speed up the manufacturing process, forced air heating may be used to facilitate the curing of the glue. For efficient forced air heating, it is important that the heated air is blown through the hollow blade shell, along the full length of the one or more installed shear webs inside the blade, without losing heated air to the environment outside the blade.

A known solution achieving these aims to a certain extent is to tightly attach a fabric cover over the root end of the wind turbine blade. A supply duct and a return duct pierce through a central portion of the fabric and make the blade cavity part of a closed forced air heat circuit that further comprises a compressor and a heater. The central location of the supply and return ducts in the fabric ensure that the heated air is blown into both the leading edge portion and the trailing edge portion of the blade cavity. While this known solution does help to speed up the curing process, the installation of the fabric onto the root end is a labour-intensive and time-consuming activity. Furthermore, it is observed that the sealing obtained by the installation of the fabric is sub-optimal. Leakage of hot air from the forced air heating circuit leads to energy inefficiencies and a loss of air pressure, which may make it difficult to effectively cure the glue at locations closer to the tip of the wind turbine blade.

It is against this background that the present invention is set.

### SUMMARY OF THE INVENTION

According to an aspect of the invention there is provided a method of curing a bond joint in a wind turbine blade manufacturing process. This method comprises a step of mechanically coupling a root cap to a root end of a wind turbine blade that is being manufactured, a step of inflating an inflatable seal for sealing a connection between the root cap and an inner surface of the root end of the wind turbine blade, and a step of blowing hot air through a hot air duct in the root cap, into a blade cavity of the wind turbine blade.

This new method of curing the bond joints ensures both an easier installation process for the curing equipment and a faster, more energy efficient, curing process. When the seal has not been inflated yet, the root cap can be easily applied just by moving it to the intended position. The subsequent inflating of the seal will then ensure that the root cap remains in place and that no air can escape from between the interface of the root cap with the root end of the wind turbine blade. As a result, effectively all hot air that is subsequently blown into the blade cavity is used for promoting the curing process and hardly any heated air is lost to the external environment of the wind turbine blade.

In an alternative aspect, there is provided a method of curing a bond joint in a wind turbine using a mobile heating device, wherein the mobile heating device comprises a mobile frame and a root cap, the root cap is supported by the mobile frame and is configured to be coupled to a root end of a wind turbine blade, wherein the method comprises
mechanically coupling the root cap to the root end of the wind turbine blade using a releasable connection system,
sealing a connection between the root cap and a surface of the root end of the wind turbine blade using a seal,
blowing hot air through a hot air duct in the root cap, into a blade cavity of the wind turbine blade.

The releasable connection system is arranged to apply a force on the root cap so that the desired position of root cap relative to the root end is secured and/or so that root cap is pressed towards the root end. Examples of the releasable connection means comprises electromagnets and/or mechanical clamps. The force applied by the releasable connection system may assist in providing the sealing.

The sealing may be achieved by inflating an inflatable seal for sealing a connection between the root cap and an inner surface of the root end of the wind turbine blade or by use of other sealing means such as resilient sealing means like o-rings.

In preferred embodiments of this new method the steps of inflating the inflatable seal and of blowing hot air through the hot air duct make use of a shared source of compressed air. For example, the air used for inflating the seal is provided through an inflation duct that branches off from the main hot air duct. Alternatively, the inflation duct is a completely separate duct, connected to a separate outlet of the common source of compressed air. The source of compressed air preferably is a closed circuit comprising a compressor and a heater. A return duct extending through the root cap may lead the partly cooled air back from the blade cavity to the compressor and heater for reheating and subsequent supply to the hot air duct for reintroduction into the blade cavity. In an alternative, less preferred, embodiment, a fan or compressor takes in air from the surroundings and blows it through a heater into the hot air duct.

Preferably, the step of blowing hot air into the blade cavity comprises expelling hot air from a first hot air outlet at a leading edge side of a shear web of the wind turbine blade and from a separate second hot air outlet at a trailing edge side of the shear web. Alternatively, a single hot air outlet is positioned centrally and blows the hot air along both sides of the shear web. A disadvantage of the use of such a single central hot air outlet is that a portion of the hot air is blown against a frontal surface of the shear web, which may result in undesirable turbulence and an increased amount of hot air directly disappearing into the return duct without first passing the shear web and the bond joint to be cured. These disadvantages may be avoided by the provision of two separate hot air outlets at respective sides of the shear web. Preferably, a common hot air duct splits in two branches just before, or just after, passing through the root cap. Alternatively, separate hot air ducts lead to the two separate hot air outlets.

The step of mechanically coupling the root cap to the root end of the wind turbine blade may comprise coupling the root cap to a root plate that is connected to the root end of the wind turbine blade. Examples of such a root plate are, e.g., described in detail in the international patent application published as WO 2021/069399 A1. The purpose of such root plates is to later serve as an interface for bolting the wind turbine blade to the rotor hub of the wind turbine.

Advantageously, the mechanically coupling the root cap to the root end of the wind turbine blade comprises activating a plurality of electromagnets. Electromagnets may bring the advantage of easily and instantly providing a strong coupling between the root cap and the root end of the blade. In addition to locking the root cap to the root end of the blade, the strong coupling provided by the electromagnets may assist in tightening the seal between the root cap and the blade, thereby ensuring that no hot air involuntarily escapes the blade cavity. The use of electromagnets is especially advantageous when a metal root plate is installed at the root end of the blade. Alternatively, the electromagnets may adhere to other ferromagnetic parts that are present at the root end of the blade.

In preferred embodiments, the root cap is supported by a mobile frame. This allows to the same root cap to be used repeatedly at different locations and to store the root cap elsewhere when not in use. A compressor and/or heater may be installed on the same mobile frame, or on a separate mobile frame. Because not all blade moulds may be built at the exact same height, the step of mechanically coupling the root cap to the root end of the wind turbine blade may comprise adjusting a vertical position of the root cap relative to the mobile frame. This may, e.g., also be useful if the same mobile frame is used with a number of different exchangeable root caps having different diameters.

According to another aspect of the invention, a mobile heating device for use in a method as described above is provided. The mobile heating device comprises a mobile frame, a root cap, a seal, a hot air duct, and a return duct. The root cap is supported by the mobile frame and configured to be coupled to a root end of a wind turbine blade that is being manufactured. The seal is provided on the root cap and arranged for sealing a connection between the root cap and an inner surface of the root end of the wind turbine blade. The hot air duct passes through the root cap and is arranged to blow hot air into a blade cavity of the wind turbine blade. The return duct passes through the root cap and is arranged to receive a return flow of air from the blade cavity.

The mobile heating device may further comprise a releasable connection system.

The shape of the seal preferably corresponds to the shape of the circumference of the blade cavity opening at the root end of the blade. The seal may, e.g., be arranged on the surface of the root cap that, in use, faces the blade cavity. When the root cap is coupled to the blade end, the seal may either interface with an inner surface of the blade cavity or with the end surface of the root end. The end surface of the root end of the blade may be formed by a root plate as described above. Alternatively, the seal may be located at or around an outer circumference of the root cap, or inside a flange that is pushed over the outer surface of the root end of the blade when the root cap is coupled to this blade.

The seal may be an inflatable seal that, in a deflated state, is small enough to be inserted into the blade cavity opening. When inflating the seal, the outer diameter of the seal expands and obtains a tight fit against the inner surface of the blade cavity opening. Alternatively, the inflatable seal may be located at an outer circumference of the root cap, such that the complete root cap can be inserted into the blade cavity opening when the seal is in a deflated state. In yet another alternative arrangement, the inflatable seal is pushed over the outer surface of the root end of the blade when in a deflated state and its inner diameter shrinks to obtain a tight fit with the outer surface of the blade when the seal is inflated.

As an alternative to the use of an inflatable seal, an O-ring made of rubber or some other resilient material may be used. The O-ring may be spring-loaded to achieve a tight fit and high-quality seal when the root cap is mounted to the root end of the blade. Electromagnets or mechanical clamps used to connect the root cap to the root end of the blade may be arranged such that they simultaneously contribute to the tightening of the seal.

In preferred embodiments, an air outlet of the hot air duct is positioned above an air inlet of the return duct when the root cap is coupled to the root end of the wind turbine blade. As a result hot air enters the cavity nearer to the top end of the shear web. As the hot air travels along the shear web towards the tip of the blade, the air may gradually cool down and fall down before it returns towards the return duct while traveling nearer to the bottom end of the shear web. Advantageously, a separation between the air outlet of the hot air duct and air inlet of the return duct is maximised to provide for a stable airflow through the blade cavity and an optimal use of the air pressure and heating capacity provided by the compressor and heating system connected to the two air ducts (i.e., the hot air duct and the return duct) of the mobile heating device.

Preferably, the root cap comprises a rigid plate, shaped to at least substantially cover the root end of the wind turbine blade. The rigid plate may, e.g., be made of a plastic, or a metal, such as steel or aluminium. By fully covering the root end of the wind turbine blade, it can be ensured that the only air flowing into and out of the blade cavity enters and leaves through the two air ducts.

Optionally, the rigid plate comprises a hinge that allows folding down an upper portion of the rigid plate from a connection configuration to a transport configuration. The folding down of the upper portion of the rigid plate into the transport configuration makes it possible to significantly reduce the total height of the mobile heating device and easier to move the mobile heating device around in location with a limited height clearance. Furthermore, folding down the upper portion of the rigid plate may help to increase the weight balance of the mobile heating device when not connected to the root end of a wind turbine blade. As a result, the mobile heating device is more stable when moving it around in the transport configuration. One or more electric, pneumatic, or hydraulic actuators may be provided for folding the upper portion of the rigid plate.

In embodiments with a folding rigid plate, a downstream end of the hot air duct may be located in the upper portion of the rigid plate, while an upstream end of the hot air duct is mounted to the mobile frame. A middle section of the hot air duct may then be configured to fluidly connect the downstream end to the upstream end when the rigid plate is in the unfolded connection configuration, while allowing for moving the downstream portion relative to the upstream portion when folding down the upper portion of the rigid plate. This may, e.g., be achieved by disconnection of the middle section at one or both ends. Alternatively, the middle section may be made of a fabric or other type of flexible material, or it may include a telescopic mechanism that allows for reducing the distance between the two ends of the middle section while folding the upper portion down to transport configuration.

Preferably, as already described above, the root cap comprises a plurality of electromagnets, arranged to electromagnetically engage with a ferromagnetic portion of the root end of the wind turbine blade. For example, the electromagnets may be evenly distributed along the circumference of the root cap and arranged to adhere to a root plate that is connected to the root end of the wind turbine blade. The electromagnets may be powered by an external AC or DC electric power supply, or by one or more, preferably rechargeable, electric batteries provided on the mobile heating device.

### BRIEF DESCRIPTION OF THE DRAWINGS

Examples of the invention will now be described with reference to the accompanying drawings, in which:

FIG. 1 schematically illustrates a wind turbine.

FIG. 2 shows a perspective view of an embodiment of a mobile heating device according to the invention.

FIG. 3 shows a different perspective view of the mobile heating device shown in FIG. 2.

FIG. 4 shows a variation of the mobile heating device shown in FIGS. 2 and 3.

FIGS. 5a and 5b illustrate an airflow through a wind turbine blade cavity as may be achieved with the mobile heating device shown in FIG. 4.

FIGS. 6 and 7 show two different perspective views of the mobile heating device shown in FIGS. 2 and 3, with the root cap in a folded configuration.

### DETAILED DESCRIPTION

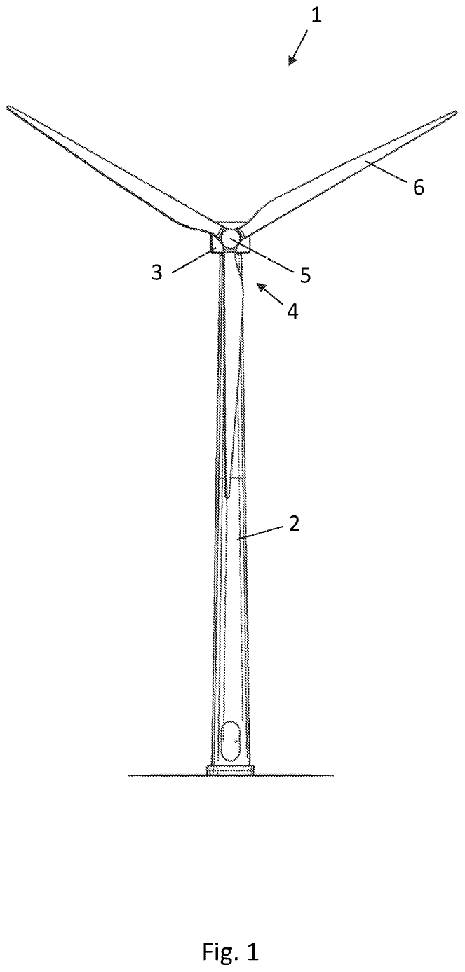

FIG. 1 illustrates, in a schematic view, an example of a wind turbine 1. The wind turbine 1 includes a tower 2, a nacelle 3 disposed at the apex of, or atop, the tower 2, and a rotor 4 operatively coupled to a generator housed inside the nacelle 3. In addition to the generator, the nacelle 3 houses other components required for converting wind energy into electrical energy and various components needed to operate, control, and optimise the performance of the wind turbine 1. The rotor 4 of the wind turbine 1 includes a central hub 5 and three rotor blades 6 that project outwardly from the central hub 5.

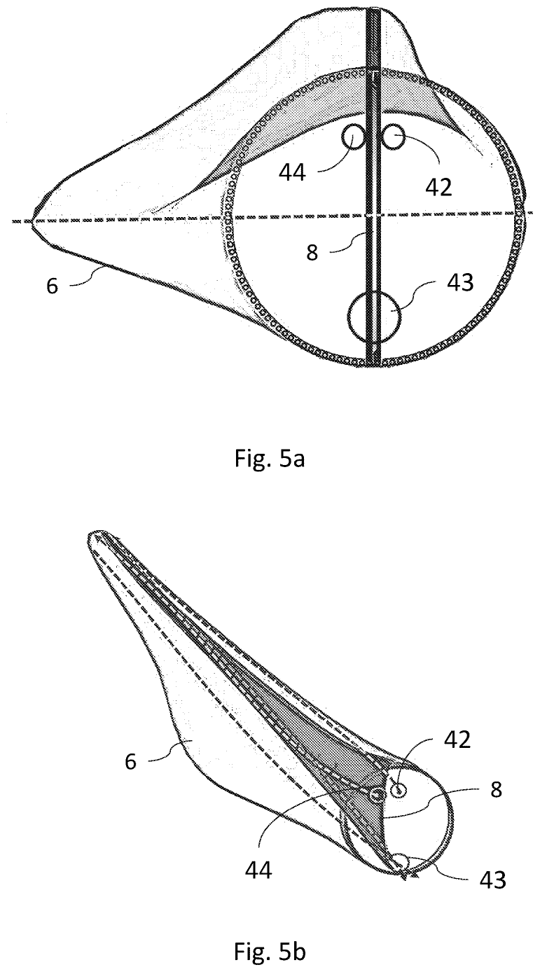

The rotor blades 6 generally comprise a hollow blade shell defining the aerodynamic contour of the blade 6. The hollow blade shell is typically formed of composite materials, such as glass-fibre reinforced plastic. In a typical manufacturing process, windward and leeward half shells are manufactured in respective half moulds of a blade mould assembly. The thus produced half shells are put together to define the aerodynamic contour of the blade 6. One or more longitudinally-extending shear webs 8 (see FIGS. 5a and 5b) are installed inside the hollow blades 6 and act as the main loadbearing structures thereof. A shear web 8 is configured to take up the shear loads experienced by the wind turbine blade 6 in use, and is connected between inner surfaces, such as spar caps, of the opposing windward and leeward sides of the shell.

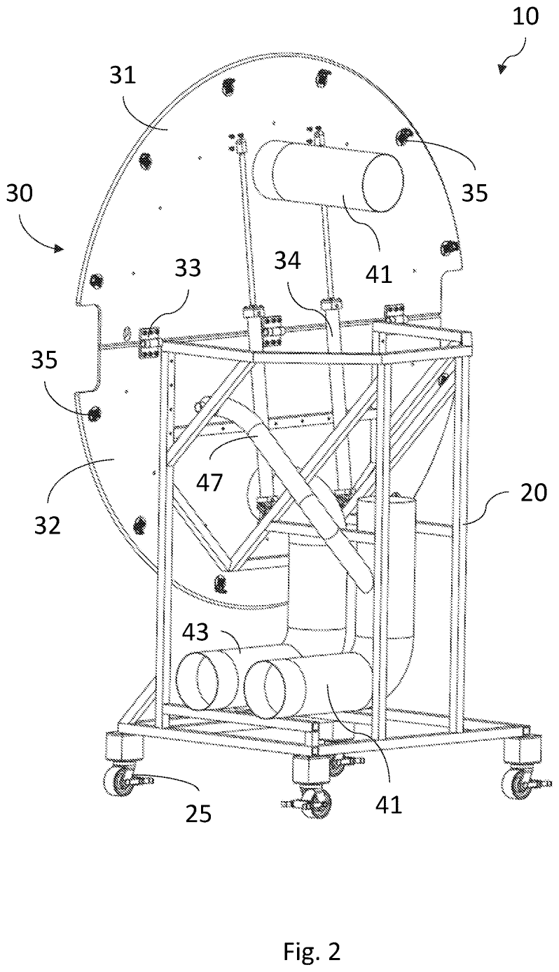

The shear web 8 is connected to the blade shells or spar caps using a glue or binding resin. Additionally, glue or binding resin is applied between opposing edges at the leading and trailing edges of the windward and leeward half shells. The adhesive, i.e. the glue or binding resin, forms an adhesive joint or bond joint. Other parts of the wind turbine blade than the shear web and shell edges may be connected using a bond joint. To improve bonding and speed up the manufacturing process, forced air heating is used to facilitate the curing of the glue. For efficient forced air heating, it is important that the heated air is blown through the hollow blade shell, along the full length of the one or more installed shear webs 8 inside the blade 6, without losing heated air to the environment outside the blade 6. For providing the desired efficient forced air heating, a mobile heating device 10 is provided, some examples of which will now be described with reference to FIGS. 2 to 7.

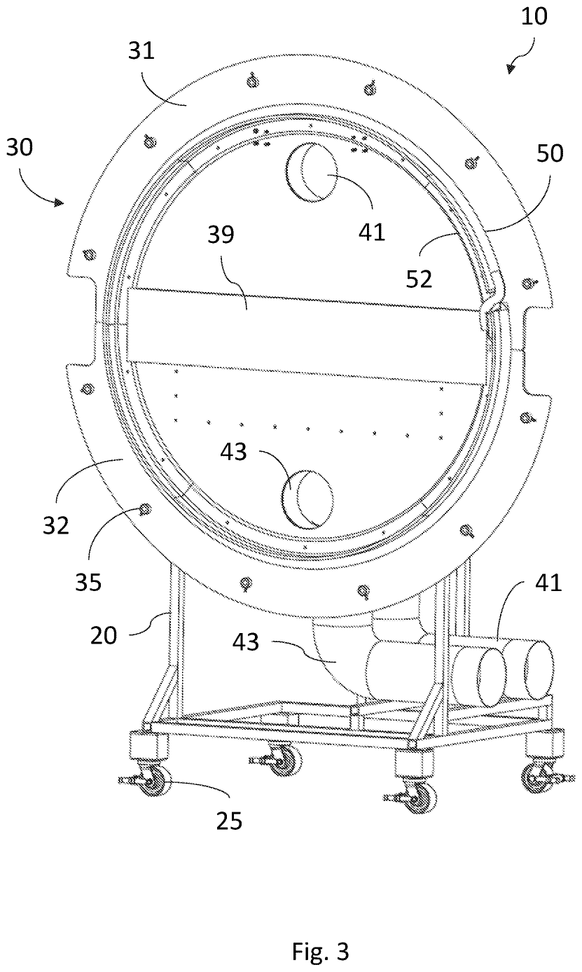

FIGS. 2 and 3 show two different perspective views of an embodiment of a mobile heating device 10 according to the invention. FIG. 2 shows the mobile heating device 10 from the side facing away from the blade cavity when being used. FIG. 3 shows the side of the mobile heating device 10 that faces towards the blade cavity.

The mobile heating device 10 comprises a mobile frame 20, a root cap 30, a seal 50, a hot air duct 41, and a return duct 43. In this embodiment, the root cap 30 is provided as a rigid plate that is supported by the mobile frame 20 and configured to be coupled to a root end of a wind turbine blade 6 that is being manufactured. The seal 50 is provided on the blade cavity facing surface of the root cap 30 and arranged for sealing a connection between the root cap 30 and an inner surface of the root end of the wind turbine blade 6. The hot air duct 41 passes through an upper portion 31 of the root cap 30 and is arranged to blow hot air into a blade cavity of the wind turbine blade 6. The return duct 43 passes through a lower portion 32 of the root cap 30 and is arranged to receive a return flow of air from the blade cavity.

The shape of the seal 50 preferably corresponds to the shape of the circumference of the blade cavity opening at the root end of the blade 6. In most cases, like in this example, this will mean that the seal 50 is preferably substantially circular. However, other blade designs may ask for differently shaped seals. In this embodiment, the seal 50 is arranged on the inner surface of the root cap 30, i.e. on the surface that, in use, faces the blade cavity. When the root cap 30 is coupled to the blade end, an outer portion of the root cap 30 lies against, and may extend radially outward of, an end surface of the root end of the blade 6. This end surface may be an outward facing surface of a root plate. In use, the seal 50 lies against an inner surface of the blade cavity. If a root plate is mounted to the root end of the blade 6, the seal 50 may partly or fully lie against an inner surface of the root plate.

In alternative embodiments, the seal 50 may be received in a complementary groove provided in the end surface of the root end of the blade 6 or of a root plate attached thereto. In further alternative embodiments, the seal 50 may be located around an outer circumference of the root cap 20. In such an embodiment, the complete root cap 30 is inserted into the blade cavity. In yet another alternative embodiment, the root cap 30 may comprise a flange that extends over an outer surface of the blade 6. In such embodiment, the seal 50 may be positioned between this flange and the outer surface of the blade 6.

In this embodiment, the seal 50 is inflatable. In a deflated state, the seal 50 is small enough to be inserted into the blade cavity opening. When inflating the seal 50, the outer diameter of the seal 50 expands and obtains a tight fit against the inner surface of the blade cavity opening. As can be seen in FIG. 3, the inflatable seal 50 is arranged around a circular rim 52 that ensures that the seal 50 expands in a radially outward direction when inflated.

Preferably, a single source of compressed air is used for inflating the inflatable seal 50 and for blowing hot air through the hot air duct 41. For example, as shown in FIG. 2, the air used for inflating the seal 50 is provided through an inflation duct 47 that branches off from the main hot air duct 41. Alternatively, the inflation duct 47 is a completely separate duct, connected to a separate outlet of the common source of compressed air. If a separate compressor is used, just for inflating the seal 50, this separate compressor is preferably placed on the mobile heating device 10 and close to the seal. For example, it may be mounted to the same root cap surface as where the seal 50 itself is located.

As an alternative to the use of an inflatable seal 50, an O-ring made of rubber or some other resilient material may be used. The O-ring may be spring-loaded to achieve a tight fit and high-quality seal when the root cap 30 is mounted to the root end of the blade 6.

The root cap 30 shown here comprises a plurality of electromagnets 35, arranged to electromagnetically engage with a ferromagnetic portion of the root end of the wind turbine blade 6. In this case, twelve electromagnets 35 are evenly distributed along the circumference of the root cap 3 and arranged to adhere to a root plate that is connected to the root end of the wind turbine blade 6. Other embodiments may use a different number of electromagnets 35. The electromagnets 35 may be powered by an external AC or DC electric power supply, or by one or more, preferably rechargeable, electric batteries provided on the mobile heating device 10.

In addition to locking the root cap 30 to the root end of the blade 6, the strong coupling provided by the electromagnets 35 may assist in tightening the seal 50 between the root cap 30 and the blade 6, thereby ensuring that no hot air involuntarily escapes the blade cavity. As an alternative or in addition to the use of electromagnets 35, mechanical clamps may be used to tightly connect the root cap 30 to the root end of the blade 6.

The mobile frame 20 to which the root cap 30 is attached allows to the same root cap 30 to be used repeatedly at different locations and to store the root cap 30 elsewhere when not in use. A compressor and/or heater for blowing hot air through the hot air duct 41, into the blade cavity may be installed on the same mobile frame 20. Alternatively, the free ends of the hot air duct 41 and the return duct 43, i.e. the ends that will do not extend through the root cap 30, are configured for coupling to an external compressor/heater circuit. The source of compressed air preferably is a closed circuit comprising a compressor and a heater. The return duct 43 extending through the root cap 30 may lead the partly cooled air back from the blade cavity to the compressor and heater for reheating and subsequent supply to the hot air duct 41 for reintroduction into the blade cavity. In an alternative, less preferred, embodiment, a fan or compressor takes in air from the surroundings and blows it through a heater into the hot air duct 41. The air leaving the return duct 43 will then be released into the same surroundings of the blade 6 and the mobile heating device 10.

Because not all blade moulds may be built at the exact same height, the step of mechanically coupling the root cap 30 to the root end of the wind turbine blade 6 may comprise adjusting a vertical position of the root cap 30 relative to the mobile frame 20. This may, e.g., also be useful if the same mobile frame 20 is used with a number of different exchangeable root caps 30 having different diameters. Adjusting the vertical position of the root cap 30 relative to the mobile frame 20 may, e.g., be done by sliding the root cap 30 along a rail.

In this and other preferred embodiments, an air outlet of the hot air duct 41 is positioned above an air inlet of the return duct 43 when the root cap 30 is coupled to the root end of the wind turbine blade 6. As a result hot air enters the cavity nearer to the top end of the shear web 8. As the hot air travels along the shear web 8 towards the tip of the blade 6, the air may gradually cool down and fall down before it returns towards the return duct 43 while traveling nearer to the bottom end of the shear web 8. Advantageously, a separation between the air outlet of the hot air duct 41 and the air inlet of the return duct 43 is maximised to provide for a stable airflow through the blade cavity and an optimal use of the air pressure and heating capacity provided by the compressor and heating system connected to the two air ducts 41, 43 of the mobile heating device 10.

The root cap 30 comprises a rigid plate, shaped to at least substantially cover the root end of the wind turbine blade 6. The rigid plate 31, 32 may, e.g., be made of a plastic, or a metal, such as steel or aluminium. By fully covering the root end of the wind turbine blade 6, it can be ensured that the only air flowing into and out of the blade cavity enters and leaves through the two air ducts 41, 43. The rigid plate 31, 32 may comprise one or more hinges 33 that allow folding down an upper portion 31 of the rigid plate 31, 32 from a connection configuration to a transport configuration. The folding down of the upper portion 31 of the rigid plate 31, 32 into the transport configuration makes it possible to significantly reduce the total height of the mobile heating device 10 and easier to move the mobile heating device 10 around in location with a limited height clearance. Furthermore, folding down the upper portion 31 of the rigid plate 31, 32 may help to increase the weight balance of the mobile heating device 10 when not connected to the root end of a wind turbine blade 6. As a result, the mobile heating device 10 is more stable when moving it around in the transport configuration. One or more electric, pneumatic, or hydraulic actuators 34 may be provided for folding the upper portion 31 of the rigid plate 31, 32.

The hinges 33 and the split between the upper portion 31 and the lower portion 32 of the rigid plate 31, 32 are designed such that, when in the unfolded connection configuration, no air can escape between the two portions 31, 32. For example, as shown in FIG. 3, a flexible seal 39 may close off any gaps that may remain between the upper portion 31 and the lower portion 32 of the root cap 30.

In this embodiment, a downstream end of the hot air duct 41 is located in the upper portion 31 of the rigid plate 31, 32, and an upstream end of the hot air duct 41 is mounted to the mobile frame 20. A middle section (not shown) of the hot air duct 41 is configured to fluidly connect the downstream end to the upstream end when the rigid plate 31, 32 is in the unfolded connection configuration. For example, the middle section may be a flexible hose that can be connected between the opposing free ends of the upstream and downstream sections visible in FIG. 2. This middle section may be disconnected at one or both ends before folding the upper portion 31 down into the transport configuration. Alternatively, the flexibility of the middle section may allow for moving the downstream portion relative to the upstream portion without disconnecting the middle section first. The middle section may be made of a fabric or other type of flexible material, or it may include a telescopic mechanism that allows for reducing the distance between the two ends of the middle section while folding the upper portion down to transport configuration.

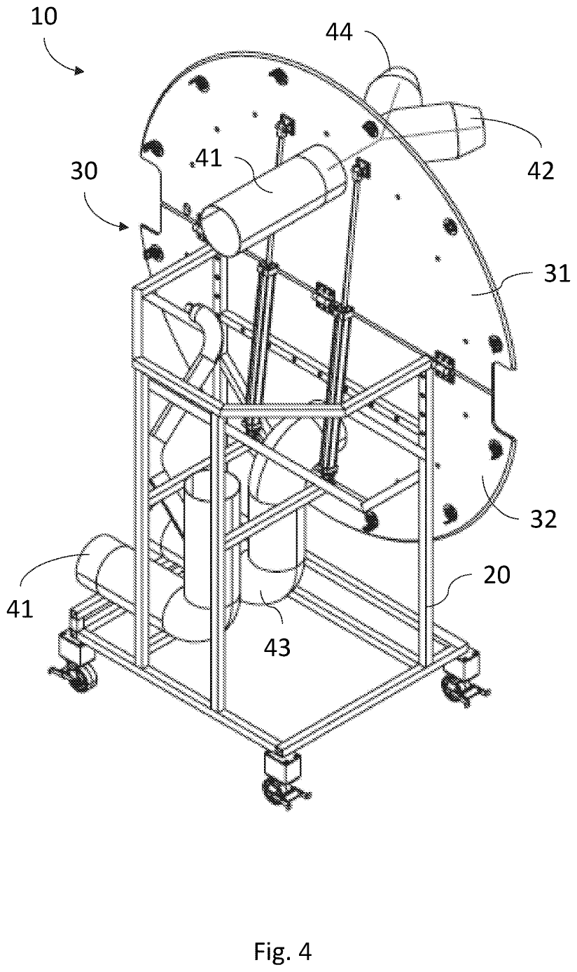

As shown in FIG. 3, a single hot air outlet is positioned in a central location from where it blows the hot air along both sides of the shear web 8. A disadvantage of the use of such a single central hot air outlet is that a portion of the hot air is blown against a frontal surface of the shear web 8, which may result in undesirable turbulence and an increased amount of hot air directly disappearing into the return duct 43 without first passing the shear web 8 and the bond joint to be cured. These disadvantages may be avoided by the provision of two separate hot air outlets 42, 44 at respective sides of the shear web 8. Preferably, a common hot air duct 41 splits in two branches just before or, as shown in the embodiment of FIG. 4, just after passing through the root cap 30. Alternatively, separate hot air ducts may lead to the two separate hot air outlets.

As illustrated in FIGS. 5a and 5b, the first hot air outlet 42 blows air in the direction of a leading edge of the blade 6 and the second hot air outlet 44 blows air in the direction of a trailing edge of the blade 6. This split results in two separate hot air streams entering the blade cavity. One hot air stream at a leading edge side of the shear web 8 and one at a trailing edge side of the shear web 8. As the hot air travels along both sides of the shear web 8 towards the tip of the blade 6, the air may gradually cool down and fall down before it returns towards a common air inlet of the return duct 43 while traveling nearer to the bottom end of the shear web 8. Alternatively, also the return duct 43 may have a split air inlet with a first air inlet at the leading edge side of the shear web 8 and a second air inlet at the trailing edge side of the shear web 8.

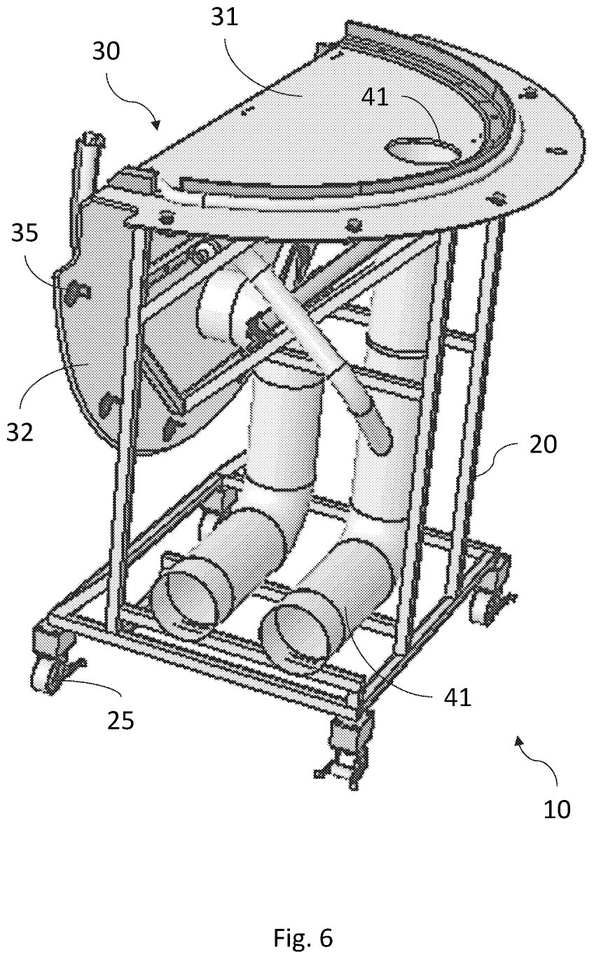

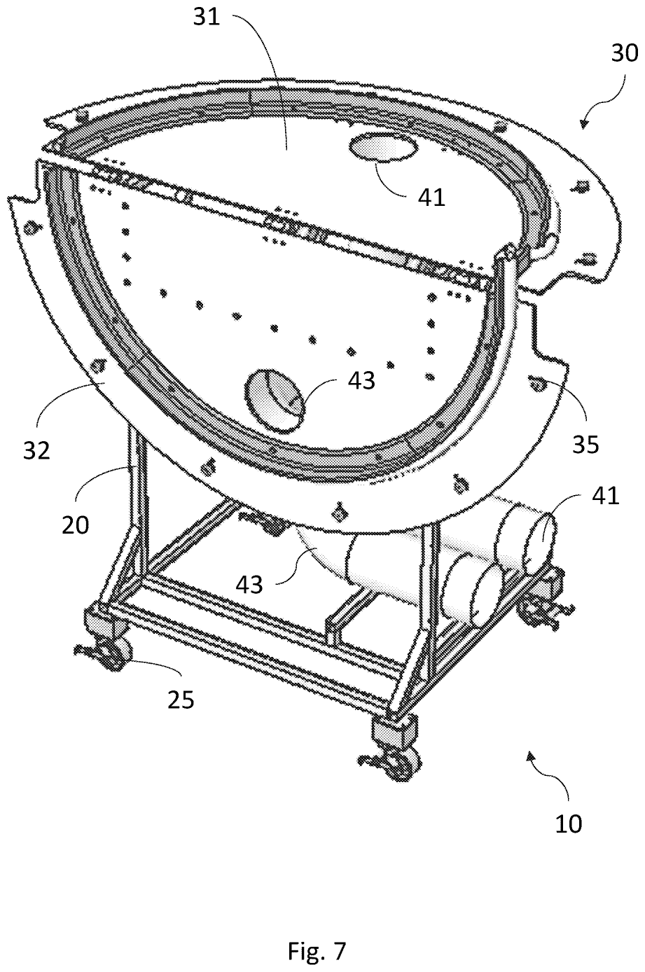

FIGS. 6 and 7 show two different perspective views of the mobile heating device 10 shown in FIGS. 2 and 3, with the root cap 30 in a folded configuration. Folding down the upper portion 31 of the root cap 30 brings the advantages of reducing the height and improving the weight balance of the mobile heating device 10. As a result, it can more easily be moved around through the blade manufacturing workshop. If placed on wheels 25, one or two engineers can easily push the mobile heating device to a different mould or a storage location. Alternatively, the mobile heating device 10 may be placed on rails for easy transport of the mobile heating device between different predetermined locations.

As described above, a middle section of the hot air duct 41 may be disconnected before folding the upper portion 31 down and reconnected after folding it up. The mobile frame 20 may comprise a storage compartment for storing the middle section when disconnected. Optionally, the middle section is stored inside the upstream and/or downstream sections of the hot air duct 41, when the root cap 30 is in its folded configuration.

1. A method of curing a bond joint in a wind turbine blade manufacturing process, the method comprising:
mechanically coupling a root cap to a root end of a wind turbine blade that is being manufactured,
inflating an inflatable seal for sealing a connection between the root cap and an inner surface of the root end of the wind turbine blade, and
blowing hot air through a hot air duct in the root cap, into a blade cavity of the wind turbine blade.

2. The method of curing a bond joint as claimed in claim 1, wherein the inflating of the inflatable seal and the blowing hot air through the hot air duct make use of a shared source of compressed air.

3. The method of curing a bond joint as claimed in claim 1, wherein the blowing hot air into the blade cavity comprises expelling hot air from a first hot air outlet at a leading edge side of a shear web of the wind turbine blade and from a separate second hot air outlet at a trailing edge side of the shear web.

4. The method of curing a bond joint as claimed in claim 1, wherein the mechanically coupling the root cap to the root end of the wind turbine blade comprises coupling the root cap to a root plate that is connected to the root end of the wind turbine blade.

5. The method of curing a bond joint as claimed in claim 1, wherein the mechanically coupling the root cap to the root end of the wind turbine blade comprises activating a plurality of electromagnets.

6. The method of curing a bond joint as claimed in claim 1, wherein the root cap is supported by a mobile frame.

7. The method of curing a bond joint as claimed in claim 6, wherein the mechanically coupling the root cap to the root end of the wind turbine blade comprises adjusting a vertical position of the root cap relative to the mobile frame.

8. A mobile heating device for curing a bond joint in a wind turbine blade, the mobile heating device comprising:
a mobile frame,
a root cap, supported by the mobile frame and configured to be coupled to a root end of a wind turbine blade that is being manufactured, a seal, provided on the root cap and arranged for sealing a connection between the root cap and a surface of the root end of the wind turbine blade,
a hot air duct, passing through the root cap and arranged to blow hot air into a blade cavity of the wind turbine blade, and a return duct, passing through the root cap and arranged to receive a return flow of air from the blade cavity.

9. The mobile heating device as claimed claim 8, wherein, when the root cap is coupled to the root end of the wind turbine blade, an air outlet of the hot air duct is positioned above an air inlet of the return duct.

10. The mobile heating device as claimed in claim 8, wherein the root cap comprises a rigid plate, shaped to at least substantially cover the root end of the wind turbine blade.

11. The mobile heating device as claimed in claim 10, wherein the rigid plate comprises a hinge, arranged to allow folding down an upper portion of the rigid plate from a connection configuration to a transport configuration.

12. The mobile heating device as claimed in claim 11, wherein:
a downstream end of the hot air duct is located in the upper portion of the rigid plate,
an upstream end of the hot air duct is mounted to the mobile frame, and
a middle section of the hot air duct is configured to fluidly connect the downstream end to the upstream end when the rigid plate is in the connection configuration, and allow for moving the downstream portion relative to the upstream portion while folding down the upper portion of the rigid plate.

13. The mobile heating device as claim in claim 8, wherein the root cap comprises a plurality of electromagnets, arranged to electromagnetically engage with a ferromagnetic portion of the root end of the wind turbine blade.

14. The mobile heating device as claimed in claim 8, wherein a downstream end of the hot air duct comprises a first hot air outlet positioned to, in use, expel hot air at a leading edge side of a shear web of the wind turbine blade and from a separate second hot air outlet at a trailing edge side of the shear web.

15. The mobile heating device as claimed in claim 8, wherein the seal is an inflatable seal.

16. The mobile heating device as claimed in claim 15, wherein the inflatable seal and the hot air duct are configured to be coupled to a shared source of compressed air.

17. Use of a mobile heating device as claimed in claim 8, for curing a bond joint in a wind turbine blade.
